(19) United States
(12) Patent Application Publication
(10) Pub. No.: US 2024/0362330 A1
(43) Pub. Date: Oct. 31, 2024

(54) AUTOMATICALLY RECOGNIZING MALICIOUS TECHNIQUES IN MALWARE

(71) Applicant: VMware LLC, Palo Alto, CA (US)

(72) Inventors: Giovanni Vigna, Santa Barbara, CA (US); Stefano Ortolani, Twickenham (GB); Roman Vasilenko, Oceanside, CA (US); Christopher Kruegel, Santa Barbara, CA (US); Saastha Vasan, Goleta, CA (US); Hojjat Aghakhani, Goleta, CA (US)

(21) Appl. No.: 18/308,274

(22) Filed: Apr. 27, 2023

(51) Int. Cl. G06F 21/56; G06F 9/54; G06N 3/044; G06N 3/045; G06N 3/0464

(52) U.S. Cl. CPC G06F 21/566; G06F 9/54; G06N 3/044; G06N 3/045; G06N 3/0464; G06F 2221/033

(57) ABSTRACT

A system that uses machine learning (ML) models—and in particular, deep neural networks—with features extracted from memory snapshots of malware programs to automatically recognize the presence of malicious techniques in such programs is provided. In various embodiments, this system can recognize the presence of malicious techniques that are defined by the MITRE ATT&CK framework and/or other similar frameworks/taxonomies.

### BACKGROUND

Unless specifically indicated herein, the approaches described in this section should not be construed as prior art to the claims of the present application and are not admitted as being prior art by inclusion in this section.

Malicious software (i.e., malware) poses a significant threat to computer networks and users, and failure to mitigate this threat can be catastrophic for organizations and individuals. A significant amount of research has been carried out to develop better malware detection and classification approaches. However, comparatively less work has been invested to create systems that can recognize the presence of specific malicious behaviors (i.e., techniques) in malware.

### BRIEF DESCRIPTION OF THE DRAWINGS

FIG. 1 depicts a high-level architecture and workflow for the system of the present disclosure according to certain embodiments.

FIG. 2 depicts a flowchart for constructing a control flow graph (CFG) according to certain embodiments.

FIG. 3 depicts a flowchart for computing a probability transition matrix according to certain embodiments.

FIG. 4 depicts an algorithm for performing a probabilistic random walk on a CFG according to certain embodiments.

FIG. 5 depicts an architecture for a deep learning pipeline according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to a system, referred to as MitrePredict, that uses machine learning (ML) models—and in particular, deep neural networks with features extracted from memory snapshots of malware programs to automatically recognize the presence of malicious techniques in such programs. As suggested by its name, in certain embodiments MitrePredict can recognize the presence of malicious techniques that are specifically defined by the MITRE ATT&CK framework, described below. Examples of MITRE ATT&CK techniques include T1055 (Process Injection), T1003 (Credential Dumping), T1089 (Disabling Security Tools), T1082 (System Information Discovery), and T1036 (Masquerading). MitrePredict can also recognize the presence of malicious techniques that are defined by other similar malware frameworks or taxonomies.

### 1. MITRE ATT&CK Framework

The MITRE ATT&CK framework is a behavioral model created by the Mitre corporation for systematically categorizing the ever-changing landscape of malware tactics, techniques, and procedures (TTPs). In recent years, it has become an industry standard approach for describing malicious behaviors.

At a high level, the MITRE ATT&CK framework categorizes malware attacks into tactics and techniques. Tactics denote short-term, tactical adversary goals for an attack. Examples of MITRE ATT&CK tactics include Persistence, Privilege Escalation, Defense Evasion, Credential Access, Discovery, Lateral Movement, Execution, Collection, Exfiltration, and Command and Control.

Techniques are technical means by which tactical goals are achieved. For example, to establish Persistence (a tactic), a malware program may add “Run Keys” to the Windows Registry, which corresponds to MITRE ATT&CK technique T1112: Modify Registry. As another example, a key logger program may first mask itself as a legitimate application in order to trick a user into executing it. Then, the key logger program may implement code obfuscation, create a registry key to achieve persistence, hook the user's keyboard to record user inputs, and eventually send the recorded input data to a command and control server using the HTTP protocol. Such behaviors correspond to the following MITRE ATT&CK techniques respectively: T1036 (Masquerading), T1027 (Obfuscated Files or Information), T1112 (Modify Registry), T1547 (Boot or Login Autostart Execution), T1056 (Input Capture), and T1071 (Standard Application Layer Protocol). The techniques library of the MITRE ATT&CK framework is constantly evolving and currently consists of more than 150 techniques, organized under the tactics mentioned above. A complete listing of these techniques can be found at https://attack.mitre.org/.

### 2. Existing Approaches for Malicious Technique Recognition

Given the ever-increasing number of malware threats, there is a significant body of research on methods for detecting malware, or in other words distinguishing between malicious and benign program samples. However, these detection methods provide little information about the specific malicious techniques that are implemented by a given piece of malware, which is critical for driving successful and comprehensive remedial actions. For example, consider a malware infection where the code includes credential access techniques (i.e., techniques that involve stealing user credentials such as account names and passwords). In this case, it is not sufficient to simply wipe and reinstall the infected host, because the existing passwords of the victim should also be invalidated and changed. As another example, consider a malware program that implements lateral movement techniques (i.e., techniques that allow an adversary to enter and control various remote systems). In this case, it would be prudent to check for potential suspicious network connections to see if other hosts/assets have been affected.

Understanding malware techniques is also important for security analysts in an organization's security operations center (SOC). These analysts are often overloaded and thus any additional context regarding an attack, such as the behaviors of the malware threat, helps to focus their attention and prioritize response tasks.

Currently, the process of recognizing the malicious techniques employed by a malware sample is carried out in a mostly manual fashion. An analyst might load the binary into a disassembler to extract its static artifacts and then combine this information with dynamic artifacts extracted using a debugger and/or network and memory forensics tools. Unsurprisingly, this process is difficult, slow, and error-prone.

There are existing tools that can use static analysis to detect the capabilities of malware programs. However, while these tools may automate some analysis tasks, they still rely on manually-written rules to model malware behaviors. As a result, they often fail to identify important behaviors, and are slow and tedious to update when new malware families implement new behaviors or old behaviors in a different way.

### 3. MitrePredict Architecture and Methodology

To address the foregoing and other related issues, embodiments of the present disclosure provide MitrePredict, a novel system that leverages deep learning to automatically identify and predict the presence of malicious techniques (as defined by the MITRE ATT&CK framework or other frameworks/taxonomies) in malware programs. MitrePredict may be implemented in software that runs on a general-purpose computer system/device, in hardware, or via a combination thereof.

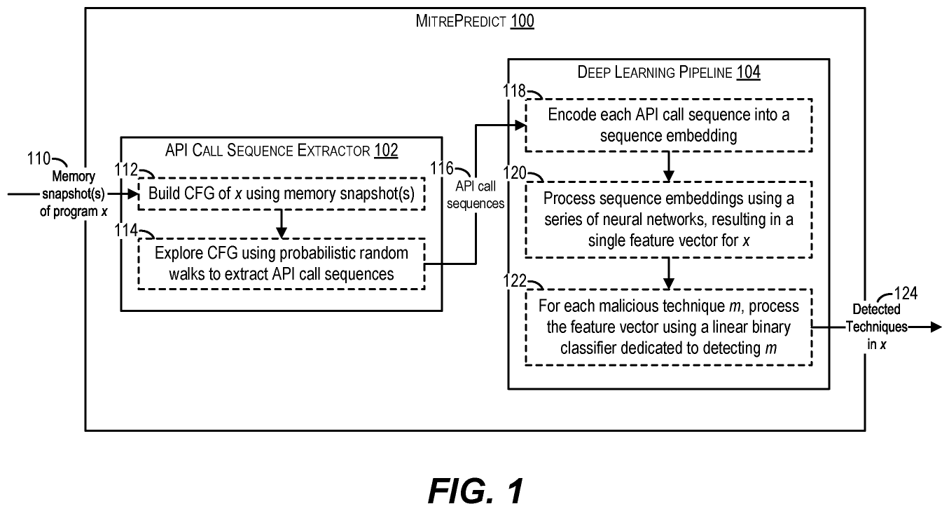

FIG. 1 depicts an example architecture 100 for MitrePredict according to certain embodiments, which includes an application programming interface (API) call sequence extractor (hereinafter simply “extractor”) 102 and a deep learning pipeline 104. FIG. 1 also depicts a high-level workflow comprising steps 110-124 that may be carried out by these components for implementing malicious technique recognition with respect to a malware program x.

Starting with step 110, extractor 102 can receive one or more memory snapshots taken from the execution of program x within a controlled environment (i.e., a sandbox). These memory snapshots, also known as process dumps, may correspond to the occurrence of particular events during the runtime of x that are deemed to be significant for analysis purposes.

At step 112, extractor 102 can build a control flow graph (CFG) of program x using the received memory snapshots. Generally speaking, a CFG is a graph-based representation of the code paths that may be traversed through a program during its execution. Upon building this CFG, extractor 102 can explore it using a series of probabilistic random walks to extract a set of API call sequences that model the program's behavior (step 114). The API calls in these sequences can include calls to both operating system (OS) APIs and library APIs, and can include calls that are not actually invoked by program x within the sandbox (i.e., calls that are reside within non-executed code).

At steps 116 and 118, deep learning pipeline 104 can receive the set of API call sequences extracted by extractor 102 and encode each sequence into a numerical representation referred to as a sequence embedding. Deep learning pipeline 104 can then process the sequence embeddings using a series of neural network models, resulting in a single feature vector for program x (step 120). In certain embodiments, these neural network models can include, among other things, a set of gated recurrent unit (GRU) models, a convolutional neural network (CNN), and a hierarchical (two-layer) attention mechanism comprising a set of API-call-level attention networks and a sequence-level attention network.

Upon generating the feature vector for program x, deep learning pipeline 104 can, for each malicious technique m that MitrePredict is configured to recognize, process the feature vector using a linear binary classifier that is dedicated to detecting m (step 122). The output of each such classifier is a prediction of whether program x implements malicious technique m or not.

Finally, at step 124, deep learning pipeline 104 can produce a list of malicious techniques that program x likely implements in accordance with the outputs of the classifiers and the workflow can end.

With the general architecture and approach shown in FIG. 1 and described above, a number of advantages are realized. First, experimental results have shown that MitrePredict is capable of achieving very high precision and recall rates across a substantial subset of techniques in the MITRE ATT&CK framework, thereby indicating its robustness as an automated malware technique recognition solution.

Second, unlike existing tools that rely on manually-crafted rules to describe malicious techniques, MitrePredict's deep learning pipeline automatically learns associations between malware code and behaviors. This makes MitrePredict more general and less likely to miss relevant techniques, or in other words less likely to suffer from false negatives.

Third, because MitrePredict extracts features from runtime memory snapshots, it can capture feature information from packed or obfuscated code, which is difficult or impossible via static analysis. Moreover, by analyzing both executed and non-executed code taken from multiple snapshots, MitrePredict achieves better code coverage than traditional dynamic analysis methods that focus solely on executed code. This is significant, as some parts of the malware code may remain dormant until specific conditions are met.

Fourth, by performing a large number of probabilistic random walks over the CFG of program x, MitrePredict is able to capture enough relevant API call sequences for it to adequately recognize malicious behavior, even in the face of evasion or obfuscation attempts by the program's author.

Fifth, by leveraging a two-level attention mechanism within its deep learning pipeline, MitrePredict can identify the specific API calls and call sequences that contribute the most towards identifying the presence of each detected technique in program x. This in turn provides valuable insights to human analysts that may be tasked with inspecting and analyzing x.

The following sub-sections describe the operation of extractor 102 and deep learning pipeline 104 in greater detail. It should be appreciated that the architecture shown in FIG. 1 is illustrative and not intended to limit embodiments of the present disclosure. For example, although FIG. 1 depicts a particular arrangement of MitrePredict components, other arrangements are possible (e.g., the functionality attributed to a particular component may be split into multiple components, components may be combined, etc.). One of ordinary skill in the art will recognize other variations, modifications, and alternatives.

### 3.1 API Call Sequence Extractor

As mentioned previously, extractor 102 is configured to extract possible API call sequences that a program under analysis (i.e., program x) may invoke, thereby capturing and modeling the program's (malicious) behavior. This strategy is effective because many malicious techniques lead to changes in a program's environment or to visible/external effects such as modifications to files or configurations, packets that are sent over the network, code that is injected into another process, or windows that are popped up. All of these changes and effects require the invocation of external (i.e., OS and library) APIs, which are captured by extractor 102.

In one set of embodiments, the operation of extractor 102 proceeds in two stages—CFG construction and CFG exploration—which are detailed below.

### 3.1.1 CFG Construction

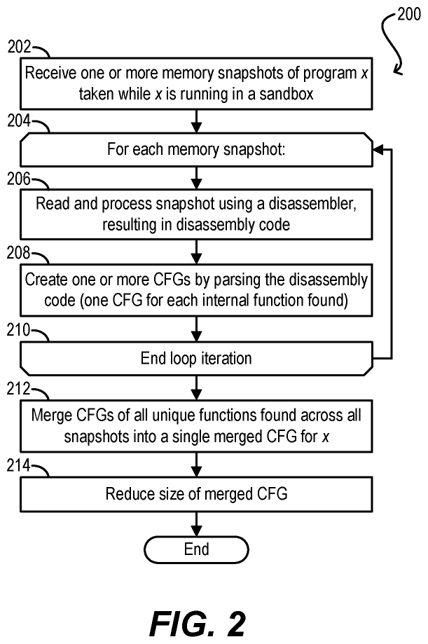

FIG. 2 depicts a flowchart 200 of the processing that may be performed by extractor 102 for constructing a CFG for program x according to certain embodiments. This processing corresponds to step 112 of the workflow of FIG. 1.

Starting with step 202 of flowchart 200, extractor 102 can receive one or more memory snapshots of program x that are taken while the program is running in a sandbox environment such as a virtual machine. In one set of embodiments, these memory snapshots can be taken in association with the occurrence of specific system events, such as (1) the execution of an API call that causes a new process creation or new file creation; (2) virtual memory execution, meaning that code execution happens outside of the program's original image; (3) initial and final state of the program during sandbox execution; and (4) when there is a change to the program's original image (e.g., code unpacking).

At step 204, extractor 102 can enter a loop for each memory snapshot received at 202 (alternatively, extractor 102 may process the snapshots in parallel). Within the loop, extractor 102 can read and process the memory snapshot using a disassembler, resulting in disassembly code (step 206). Extractor 102 can then create one or more CFGs by parsing the generated disassembly, and in particular can create one CFG for each internal function of program x found therein (step 208). Each node of a CFG G for a function F represents a code block (also called a “basic block” or simply “block”) that comprises a set of instructions which execute sequentially within F. Further, there is a directed edge from a node n₁ in G to another node n₂ in G if there is a control transfer instruction from the block associated with n₁ to the block associated with n₂.

At step 210, extractor 102 can reach the end of the current loop iteration and return to step 204 in order to process the next memory snapshot. Upon processing all memory snapshots for program x, extractor 102 can merge the CFGs of all unique functions found across all of the snapshots into a single CFG for x (step 212). In a particular embodiment, this merging process can involve creating a union of all of the CFGs, starting from the first memory snapshot to the last one. If two memory snapshots include different CFGs for a function that starts at the same memory address (or if there are overlapping functions), extractor 102 can select the CFG of the function that contains more API calls. The number of API calls might change for a given function if, e.g., a snapshot that is taken at a later time includes a concrete target for an indirect function call (and that function call invokes an external API).

Finally, at step 214, extractor 102 can reduce the size of the merged CFG to speed up the subsequent analysis process. More specifically, because MitrePredict is primarily interested in function/API invocations, extractor 102 can remove all instructions from code blocks in the CFG that are neither an internal function call nor an external API invocation. Extractor 102 can then remove all blocks from the CFG that have no instructions, while keeping the connectivity of the graph intact. For example, in one set of embodiments extractor 102 can apply the following two rules when removing blocks with no instructions:
1. Always keep the start and end blocks of each function.
2. For every other block B, if B does not contain any instruction, generate edges from all of B's parent blocks in the graph to all of its child blocks and then remove all incoming and outgoing edges for B.

### 3.1.2 CFG Exploration

Once extractor 102 has constructed the (merged) CFG for program x, it can proceed with extracting possible sequences of API calls. To this end, extractor 102 can explore the CFG by performing probabilistic random walks over it and can extract fixed-length API call sequences encountered via the walks (in the remainder of this disclosure, the fixed length of each sequence is denoted as A). This approach allows extractor 102 to extract API call sequences from the CFG in a manner that gives higher weight to the blocks including a larger number of function/API call instructions.

### 3.1.2.1 Preparing for Probabilistic Random Walks

The probabilistic random walk approach is based on Markov chains, which describe the probability of transitioning from one state to another using a transition probability matrix. Extractor 102 can compute this matrix once at the beginning of its CFG exploration and use it to select the next block/node that will be traversed to as part of each random walk.

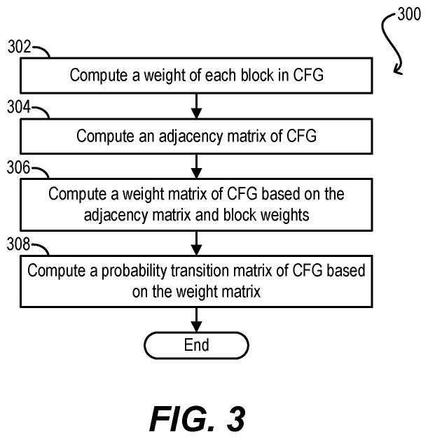

FIG. 3 depicts a flowchart 300 that may be performed by extractor 102 for computing this transition probability matrix according to certain embodiments. Starting with step 302, extractor 102 can compute a weight of each block Bᵢ in the CFB, denoted by |Bᵢ|. In one set of embodiments, this weight is the total number of function/API call instructions in that block.

At step 304, extractor 102 can compute an adjacency matrix [symbol] of the CFG. The adjacency matrix of a CFG with n blocks ordered from B₁ to Bₙ is defined as an n×n matrix [symbol] in which [symbol] _{i,j}=1 if there exists a path from Bᵢ to Bⱼ and [symbol] _{i,j}=0 otherwise.

At step 306, extractor 102 can compute a weight matrix [symbol] of CFG based on adjacency matrix A and the block weights. Weight matrix [symbol] is also a n×n matrix in which [symbol] _{i,j}= [symbol] _{i,j}+|Bⱼ| if [symbol] _{i,j}=1 and [symbol] _{i,j}=0 otherwise.

Finally, at step 308, extractor 102 can compute the probability transition matrix [symbol] of CFG using weight matrix [symbol] . Probability transition matrix [symbol] is a n×n matrix that denotes the probability of transitioning from any block in the CFG to another other block in the CFG. In a particular embodiment, the values of this matrix can be defined as

$${i , j}_{} = \frac{{𝕎}_{i , j}}{{\sum }_{t = 1}^{n} {𝕎}_{i , t}}$$

for every i, j.

### 3.1.2.2 Performing a Probabilistic Random Walk

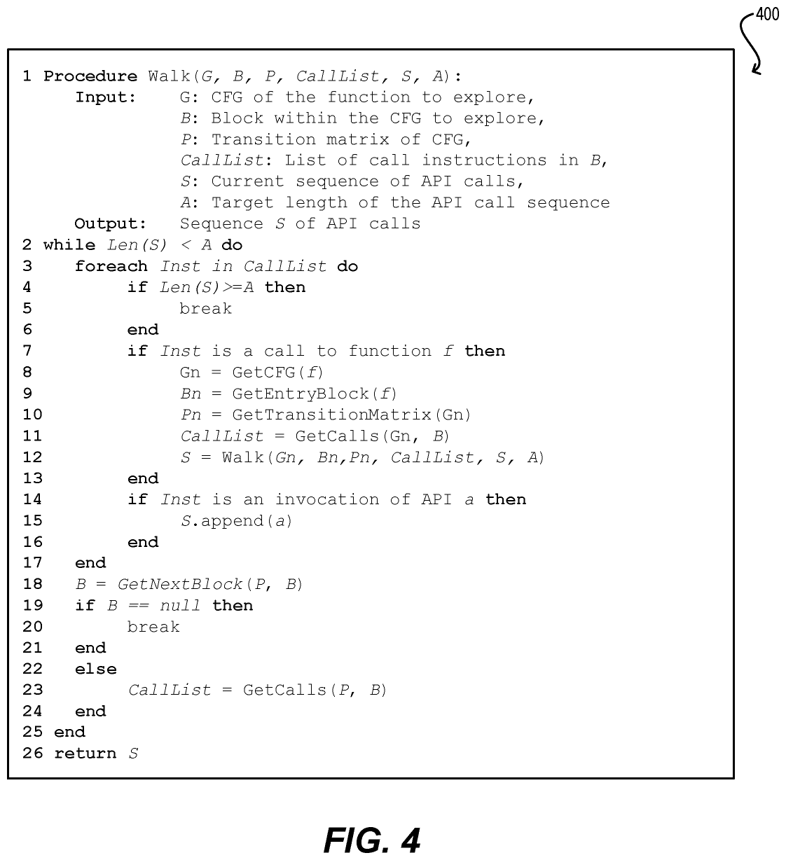

With probability transition matrix [symbol] in hand, extractor 102 can execute a number of probabilistic random walks over the CFG created for program x. FIG. 4 depicts an example algorithm 400 for carrying out these walks according to certain embodiments. As shown in FIG. 4, for each walk, extractor 102 can initialize a Walk procedure with the following input arguments: a CFG G for a randomly chosen function of program x (where G is a sub-graph within the merged CFG); a random block B in F as the starting point for the walk; the probability transition matrix [symbol] ; a CallList comprising a list of function/API call instructions in B; an empty sequence list S (which will eventually store the API call sequence determined via this walk); and the maximum API call sequence length A.

During the exploration of each block (starting with block B), extractor 102 can iterate over the instructions in the block's CallList (Line 3) and check whether they are internal function calls or external API invocations. If an instruction is a function call, extractor 102 can follow the edge in CFG G and continue the walk at the first block of the callee function (Lines 7-13). Alternatively if the instruction is an API invocation, extractor 102 can append the API name to sequence list S (Lines 14-16).

After iterating over all the instructions in a block, extractor 1023 can traverse to a next block in CFG G. To randomly select the next block (in case there are multiple successor blocks), extractor 102 can call the GetNextBlock procedure (Line 18), which takes the current block Bᵢ and probability transition matrix [symbol] as input arguments. If the current block has at least one successor block in CFG G (that is, Σⱼ₌₁ⁿ [symbol] _{i,j}=1), GetNextBlock can return one of these successor blocks by performing a weighted random selection. If the current block does not have any successor block (that is, Σⱼ₌₁ⁿ [symbol] _{i,j}=0), the procedure can simply return NULL. Extractor 102 can then continue exploring all of the blocks in CFG G until either the length of sequence list S becomes equal to maximum length A or it reaches one of the terminal blocks in the CFG. In both cases, the Walk procedure returns S.

Although not shown in FIG. 4, upon exploring CFG G via the Walk procedure, extractor 102 can check if the length of the returned sequence list S is equal to A. If so, extractor 102 can store S and start a new walk by calling Walk( ) with the CFG of a newly chosen random function of program x. On the other hand, if the length of returned sequence list S is not equal to A, extractor 102 can randomly select a function from the particular set of functions that can call the function corresponding to CFG G and can extend the current random walk from that function. This simulates a function return from G and continues the walk from one of its call sites. If no such caller function can be found, the random walk is stopped with a sequence length that is shorter than A. Such sequences may be padded to obtain a length of A before they are processed by deep learning pipeline 104 (as discussed in the next section).

An important consideration for the CFG exploration implemented by extractor 102 is that it should be robust against malware authors' attempts to evade analysis and hide relevant behaviors. The approach described here satisfies this requirement for several reasons. First, adding, reordering, or replacing non-control-flow instructions in the CFG for program x does not interfere with the exploration, because those instructions are already removed by the CFG reduction process performed at step 214 of flowchart 200.

Second, it does not matter if an attacker attempts to reorder blocks or functions, or if they add additional functions or blocks into program x. Extractor 102 extracts only API call sequences, and thus any code that does not lead to the invocation of API calls is discarded.

Third, while is possible for an attacker to insert additional API calls along “dummy” paths that are not actually executed during runtime, extractor 102 can perform many random probabilistic walks on the CFG. As a result, extractor 102 will capture a sufficient number of relevant API call sequences to adequately model the program's behaviors.

Fourth, while an attacker could also try to camouflage relevant API call sequences by adding “padding” between all calls along an execution path, this padding must add a substantial number of calls so that the fixed-length sequences extracted by extractor 102 do not contain sufficient elements of the true sequence (otherwise, MitrePredict will detect the relevant sub-sequence that is characteristic of a behavior). Adding such a large number of padding calls will cause the program to significantly deviate from normal programs, both in number and composition of API calls in the code, as well as in the API invocations that occur during runtime. These deviations would in turn make the malware easier to detect by both static and dynamic analysis solutions. Accordingly, it is highly unlikely that malware authors would expose their malware to easier detection in this manner, simply to thwart the technique recognition performed MitrePredict.

### 3.2 Deep Learning Pipeline

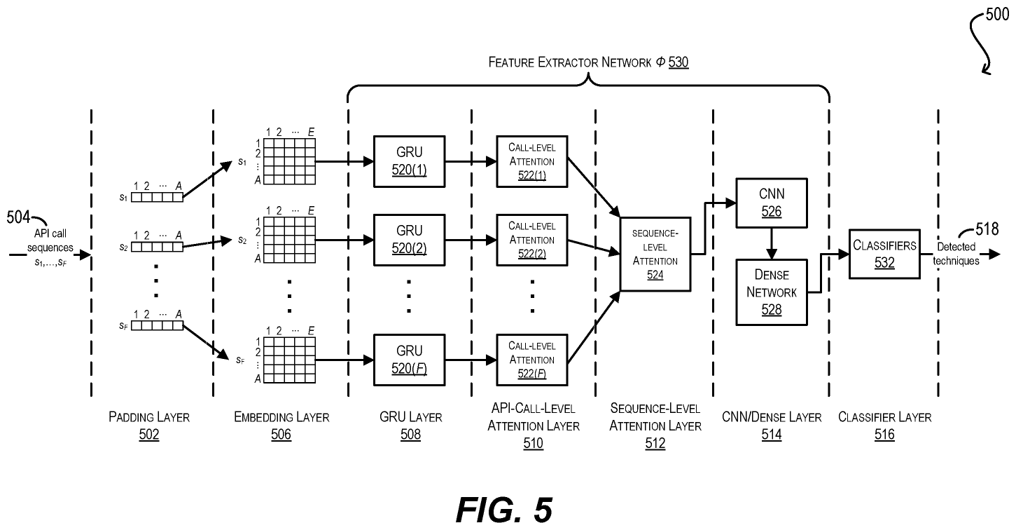

FIG. 5 depicts a diagram 500 that provides additional details regarding the architecture of MitrePredict's deep learning pipeline 104 according to certain embodiments, As shown, this architecture includes a padding layer 502 (which receives as input a collection of F API call sequences s₁, . . . , s_{F} (reference numeral 504) extracted from program x by extractor 102), an embedding layer 506, a GRU layer 508, an API-call-level attention layer 510, a sequence-level attention layer 512, a CNN/dense layer 514, and a classifier layer 516 (which produces as output a list of malicious techniques 518 detected in x). Each of these layers are discussed in turn below.

### 3.2.1 Padding Layer

As mentioned previously, in certain embodiments deep learning pipeline 104 is configured to operate solely on API call sequences having a specific fixed length (i.e., A). Accordingly, for each input sequence sᵢ with a length less than A, padding layer 502 can pad the sequence to a length of A by adding one or more padding tokens. The output of this layer is F padded sequences s₁, . . . , s_{F} of length A, or in other words a 2D array with the dimensions F×A.

### 3.2.2 Embedding Layer

Embedding layer 506 receives the padded API call sequences from padding layer 502 and converts each sequence into a numerical representation (i.e., sequence embedding) so that it can be processed by downstream stages of deep learning pipeline 104. A naïve method for performing this operation is to convert each API call in the sequence into a one-hot encoded vector that contains all zeros except for the index corresponding to the invoked API call. However, this one-hot representation leads to data sparsity in general, which is undesirable.

To avoid this problem, in certain embodiments embedding layer 506 can convert each API call in a sequence into an E-dimensional vector in a manner similar to how word embeddings are created in natural language processing (NLP) applications. In particular, embedding layer 506 can initialize these vectors with random values and then train them via a training process that causes API calls with similar names to have similar vectors. This results in a sequence embedding for each API call sequence sᵢ that takes the form of a A×E matrix.

Beyond reducing data sparsity, another advantage of this word embedding approach is that dimension E (i.e., the length of each API call vector) can be chosen to be significantly smaller than the total number of unique API calls U for program x, which is the dimension used by the one-hot encoding approach. That is, using the word embedding approach instead of one-hot encoding reduces the input size of the next layer in deep learning pipeline 104 (i.e., GRU layer 508) from F×A×U to F×A×E. This dimensionality reduction can result in faster training of the system.

### 3.2.3 GRU Layer

As shown in FIG. 5, GRU layer 508 comprises a set of F GRUs 520(1)-(F) that each receives as input a sequence embedding output by embedding layer 506. The general goal of this layer is to capture low-level sequential information in the sequence embeddings. A GRU is a type of recurrent neural network (RNN), which is in turn a neural network that is adapted to process time series data. GRUs overcome the vanishing gradient problem of conventional RNNs using two gates: update and reset. GRUs share many properties with Long Short-Term Memory (LSTM) networks, which are another type of RNN. However, unlike LSTMs, GRUs do not have an output gate, and combine the input and forget gates into a single update gate. GRUs are shown to be faster on average than LSTMs, while their performance is on par with LSTMs for short-term sequences.

In one set of embodiments, each GRU—which is assumed to include A gated units with a hidden dimension of size H—can convert each API call in the input sequence embedding it receives into a vector of size 2H (referred to as an API hidden vector). Accordingly, the output of each GRU is a set of A API hidden vectors, or in other words a matrix of size A×2H.

In a particular embodiment, each GRU can be a bidirectional GRU and, for each API call aₜ (0≤t<A) in its input sequence embedding, the t-th gated unit of the GRU can compute the following in the forward direction:

$${r}_{t} = σ ( {W}_{r} {a}_{t} + {U}_{r} {h}_{t - 1} ) \qquad Listing 1$$

$${z}_{t} = σ ( {W}_{z} {a}_{t} + {U}_{z} {h}_{t - 1} )$$

$${n}_{t} = tanh ( {W}_{h} {a}_{t} + {U}_{h} ( {r}_{t} ∘ {h}_{t - 1} ) )$$

$${h}_{t} = {z}_{t} ∘ {h}_{t - 1} + ( 1 - {z}_{t} ) ∘ {n}_{t}$$

In these equations, W and U are weight matrices and σ represents the sigmoid function. The operation ∘ represents the Hadamard product, and hₜ is the hidden state at time t (h₀=0). The reset, update, and new gates are represented by rₜ, zₜ, and nₜ respectively.

### 3.2.4 API-Call-Level Attention Layer

Not all API calls in a single API call sequence characterize the sequence's behavior equally; some calls in the sequence may be more influential or important than others. To capture this, API-call-level attention layer 510 employs F call-level attention networks 522(1)-(F). Each call-level attention network 522(i) receives as input a set of A API hidden vectors for API call sequence sᵢ from a corresponding GRU 520(i) in GRU layer 508, computes an attention weight for each API hidden vector, and outputs a “sequence hidden vector” of size 2H for sᵢ based on the attention weights. These API-call-level attention weights can subsequently be used to determine the API call(s) that contributed the most towards a given technique prediction.

The following summarizes the steps that may be performed by each call-level attention network in order to compute the attention weights and the sequence hidden vector according to certain embodiments. These steps assume that the A API hidden vectors received from preceding GRU layer 508 are denoted as H₁, . . . , H_{A}.
1. A side, shallow neural network with two layers of 2H neurons is used to compute an attention weight for each API hidden vector Hₖ.
2. The computed attention weights are passed to a softmax layer so that they can be normalized (i.e., sum up to one).
3. The normalized attention weights, denoted as vector AW, are used to compute the sequence hidden vector as a weighted sum of the API hidden vectors (i.e., Σₖ₌₁^{A} AWₖ×Hₖ).

### 3.2.5 Sequence-Level Attention Layer

The goal of sequence-level attention layer 512 is to compute sequence-level attention weights for the F API call sequences of program x, which can be later used to determine the sequence(s) that contributed the most towards a given technique prediction. To that end, layer 512 includes a singular sequence-level attention network 524 that receives as input a set of F sequence hidden vectors from call-level attention networks 522(1)-(F) (or in other words, a matrix of size F×2H where each row is a sequence hidden vector) and computes an attention weight for each sequence hidden vector. Sequence-level attention layer 512 can perform these weight computations in a manner that is largely similar to API-call-level attention layer 510.

One difference in the computation performed by sequence-level attention layer 512 is that, rather than calculating a weighted sum of sequence hidden vectors as a final step, layer 512 simply multiplies (i.e., scales) each sequence hidden vector with its corresponding normalized attention weight. Thus, the output of layer 510/network 524 is identical in size to its input (i.e., a matrix with dimensions F×2H).

### 3.2.6 CNN Dense Layer

The input to CNN/dense layer 514 is the matrix of sequence hidden vectors output by sequence-level attention layer 512, each scaled by its corresponding sequence attention weight. These vectors are first processed by a one-dimensional CNN 526, which can include a set of sliding windows, a max-pooling layer, and a flattening layer.

The output of CNN 526 is then passed to a dense network 528 that includes a dropout layer. The purpose of this dropout layer is to implement dropout randomization, which prevents over-fitting and increases performance. The output of dense network 528 is a single ζ-dimensional feature vector for program x (denoted as ϕ(x)) that captures the program's behaviors. As shown in FIG. 5, the portions of deep learning pipeline 104 comprising GRU layer 508, attention layers 510 and 512, and CNN/dense layer 514 are collectively referred to as feature extractor network ϕ (reference numeral 530).

### 3.2.7 Classifier Layer

In this final layer, deep learning pipeline 104 implements a set of linear binary classifiers 532 that map in a one-to-one manner to the malicious techniques that MitrePredict is configured to recognize. Upon receiving feature vector ϕ(x) from CNN/dense layer 514, classifier layer 516 passes the feature vector as input to each of these classifiers, denoted by gₘ, which produces a detection score gₘ(ϕ(x)) indicating whether technique m is present in program x or not. Classifier layer 516 then generates the list of detected techniques 518 based on the detection scores. For example, in a particular embodiment layer 516 can generate list 518 by processing each detection score gₘ(ϕ(x)) in accordance with an associated detection threshold εₘ as follows:
1. Technique m is present if gₘ(ϕ(x))≥εₘ;
2. m is not present if gₘ(ϕ(x))<εₘ.

### 3.3 Training

The foregoing sections explain how MitrePredict performs malicious technique recognition with respect to a given program sample. The following sub-sections elaborate on how the system may be trained according to various embodiments. This training generally proceeds in two main stages: a base stage and a fine-tuning stage.

### 3.3.1 Base Stage

The goal of the base stage is to build feature extractor network ϕ, which produces the feature vector that is processed by classifier layer 516. In one set of embodiments, this involves (1) creating a generic version of network ϕ in a system comprising linear binary classifiers g₁, . . . , gₘ for malicious techniques 1, . . . , M, and (2) training ϕ on a training dataset D (which contains ground-truth labels for all of the techniques) using a multi-task learning paradigm. For example, in a particular embodiment the training process can optimize cross-entropy loss (denoted by L), computed over different samples and techniques, as follows:

$${min}_{θ , {θ}_{1} , ... {θ}_{M}} {𝔼}_{( x , {y}_{1} , ... , {y}_{M} ) ∼ D} ( {\sum }_{m = 1}^{M} L ( {g}_{m} ( ϕ ( x ) ) , {y}_{m} ) ) \qquad Listing 2$$

In this equation, θ, θ₁, . . . , θ_{M} represent the parameters of ϕ and the classifiers {gₘ}ₘ₌₁^{M}.

### 3.3.2 Fine-Tuning Stage

The goal of the fine-tuning stage is to fine-tune the performance of the linear binary classifiers. In one set of embodiments, this involves cloning feature extractor network ϕ for each technique m (i.e., ϕ′(x)←ϕ(x)) and appending a new classifier ĝₘ to it. Classifier ĝₘ(ϕ′(x)) is then fine-tuned for the task of detecting technique m by optimizing the following loss function:

$${min}_{{θ′}_{m} , {\hat{θ}}_{m}} {𝔼}_{( x , {y}_{m} ) ∼ {D}^{< m >}} ( {\sum }_{m = 1}^{M} L ( {\hat{g}}_{m} ( {ϕ}^{′} ( x ) ) , {y}_{m} ) ) \qquad Listing 3$$

In this equation, θ′ₘ, \hat{θ}ₘ represent the parameters of ϕ′(x) and the linear classifier ĝₘ.

After the fine-tuning process, MitrePredict will have a dedicated classifier for each technique m (i.e., ĝₘ(ϕ′(x))), which can be used to predict whether m is present in program x or not.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, one or more memory snapshots taken of a malware program while the malware program is running in a controlled environment;
determining, by the computer system, a plurality of application programming interface (API) call sequences included in the malware program using the one or more memory snapshots; and
processing, by the computer system, the plurality of API call sequences using one or more machine learning (ML) models, the processing resulting in a list of malicious techniques used by the malware program.

2. The method of claim 1 wherein the determining comprises:
building a control flow graph for the malware program based on the one or more memory snapshots; and
performing a plurality of probabilistic random walks on the control flow graph to generate the plurality of API call sequences.

3. The method of claim 1 wherein each API call in each API call sequence is an invocation of an operating system (OS) or library API by the malware program.

4. The method of claim 1 wherein the processing comprises:
encoding the plurality of API call sequences into a plurality of sequence embeddings;
processing the plurality of sequence embeddings using a feature extractor neural network to generate a feature vector for the malware program; and
for each malicious technique in a plurality of malicious techniques, processing the feature vector using a linear binary classifier that is configured to predict whether said each malicious technique is present in the malware program.

5. The method of claim 4 wherein the feature extractor network includes a plurality of gated recurrent unit (GRU) networks, a plurality of API-call-level attention networks, a sequence-level attention network, and a convolutional neural network (CNN).

6. The method of claim 4 wherein the processing of the plurality of sequence embeddings using the feature extractor neural network comprises:
determining, for each API call in each API call sequence, an API-call-level attention weight indicating a degree to which said each API call contributes to a prediction that a particular malicious technique is present in the malware program; and
determining, for said each API call sequence, a sequence-level attention weight indicating a degree to which said each API call sequence contributes to the prediction.

7. The method of claim 1 wherein the list of malicious techniques includes one or more techniques defined by the MITRE ATT&CK framework.

8. A non-transitory computer readable storage medium having stored thereon program code executable by a computer system, the program code embodying a method comprising:
receiving one or more memory snapshots taken of a malware program while the malware program is running in a controlled environment;
determining a plurality of application programming interface (API) call sequences included in the malware program using the one or more memory snapshots; and
processing the plurality of API call sequences using one or more machine learning (ML) models, the processing resulting in a list of malicious techniques used by the malware program.

9. The non-transitory computer readable storage medium of claim 8 wherein the determining comprises:
building a control flow graph for the malware program based on the one or more memory snapshots; and
performing a plurality of probabilistic random walks on the control flow graph to generate the plurality of API call sequences.

10. The non-transitory computer readable storage medium of claim 8 wherein each API call in each API call sequence is an invocation of an operating system (OS) or library API by the malware program.

11. The non-transitory computer readable storage medium of claim 10 wherein the processing comprises:
encoding the plurality of API call sequences into a plurality of sequence embeddings;
processing the plurality of sequence embeddings using a feature extractor neural network to generate a feature vector for the malware program; and
for each malicious technique in a plurality of malicious techniques, processing the feature vector using a linear binary classifier that is configured to predict whether said each malicious technique is present in the malware program.

12. The non-transitory computer readable storage medium of claim 11 wherein the feature extractor network includes a plurality of gated recurrent unit (GRU) networks, a plurality of API-call-level attention networks, a sequence-level attention network, and a convolutional neural network (CNN).

13. The non-transitory computer readable storage medium of claim 11 wherein the processing of the plurality of sequence embeddings using the feature extractor neural network comprises:
determining, for each API call in each API call sequence, an API-call-level attention weight indicating a degree to which said each API call contributes to a prediction that a particular malicious technique is present in the malware program; and
determining, for said each API call sequence, a sequence-level attention weight indicating a degree to which said each API call sequence contributes to the prediction.

14. The non-transitory computer readable storage medium of claim 8 wherein the list of malicious techniques includes one or more techniques defined by the MITRE ATT&CK framework.

15. A computer system comprising:
a processor; and
a non-transitory computer readable medium having stored thereon program code that, when executed by the processor, causes the processor to:
receive one or more memory snapshots taken of a malware program while the malware program is running in a controlled environment;
determine a plurality of application programming interface (API) call sequences included in the malware program using the one or more memory snapshots; and
process the plurality of API call sequences using one or more machine learning (ML) models, the processing resulting in a list of malicious techniques used by the malware program.

16. The computer system of claim 15 wherein the program code that causes the processor to determine the plurality API call sequences comprises program code that causes the processor to:
build a control flow graph for the malware program based on the one or more memory snapshots; and
perform a plurality of probabilistic random walks on the control flow graph to generate the plurality of API call sequences.

17. The computer system of claim 15 wherein each API call in each API call sequence is an invocation of an operating system (OS) or library API by the malware program.

18. The computer system of claim 17 wherein the program code that causes the processor to process the plurality API call sequences comprises program code that causes the processor to:
encode the plurality of API call sequences into a plurality of sequence embeddings;
process the plurality of sequence embeddings using a feature extractor neural network to generate a feature vector for the malware program; and
for each malicious technique in a plurality of malicious techniques, process the feature vector using a linear binary classifier that is configured to predict whether said each malicious technique is present in the malware program.

19. The computer system of claim 18 wherein the feature extractor network includes a plurality of gated recurrent unit (GRU) networks, a plurality of API-call-level attention networks, a sequence-level attention network, and a convolutional neural network (CNN).

20. The computer system of claim 18 wherein the program code that causes the processor to process the plurality of sequence embeddings using the feature extractor neural network comprises program code that causes the processor to:
determine, for each API call in each API call sequence, an API-call-level attention weight indicating a degree to which said each API call contributes to a prediction that a particular malicious technique is present in the malware program; and
determine, for said each API call sequence, a sequence-level attention weight indicating a degree to which said each API call sequence contributes to the prediction.

21. The computer system of claim 15 wherein the list of malicious techniques includes one or more techniques defined by the MITRE ATT&CK framework.
